(19) United States
(12) Patent Application Publication
(10) Pub. No.: US 2022/0396247 A1
(43) Pub. Date: Dec. 15, 2022

(54) ROAD FRICTION ESTIMATION

(71) Applicant: David D. Carr, JR., Brighton, MI (US)

(72) Inventor: David D. Carr, JR., Brighton, MI (US)

(21) Appl. No.: 17/348,342

(22) Filed: Jun. 15, 2021

(51) Int. Cl. B60T 8/172; B60W 40/068

(52) U.S. Cl. CPC B60T 8/172; B60W 40/068; B60T 2210/12; B60W 2520/10; B60W 2540/18; B60W 2710/202; B60W 2510/305

(57) ABSTRACT

In at least some implementations, a method of estimating road friction, includes determining an actual steering load, determining a nominal steering load as a function of vehicle speed, steering angle, and a nominal road friction value, and comparing the actual steering load to the nominal steering load to determine an estimated road friction. In at least some implementations, the nominal steering load is not determined as a function of vehicle yaw, or vehicle lateral acceleration, or vehicle wheel speed compared to vehicle speed, or vehicle tire compliance or road wheel angle.

### FIELD

The present disclosure relates to methods to estimate road friction and to control a vehicle in response to a road friction estimate.

### BACKGROUND

Typical automotive vehicles include a range of sensors to determine vehicle speed, steering angle, steering forces, lateral acceleration, vehicle yaw or yaw rate, vehicle wheel speed, and the like. Some vehicles include anti-lock braking systems that serve to reduce or avoid wheel skid during hard braking events, and stability control systems that may apply brakes to individual wheels to avoid or reduce vehicle spinning or sliding or such yaw or lateral accelerations. Some vehicle systems seek to estimate the actual friction of a road on which the vehicle is traveling to assist in control of the vehicle systems. The road friction estimations utilize complex models like bicycle models that include a plurality of inputs such as lateral acceleration, yaw, tire compliance, wheel speed compared to vehicle speed (e.g. to determine wheel slip). These complex models can be slower than desired, utilize noisy signals that further complicate determinations and can require vehicle yaw or lateral accelerations to occur and exceed thresholds before corrective actions are taken. All of which create meaningful delays and require more forceful corrections to stabilize the vehicle.

### SUMMARY

In at least some implementations, a method of estimating road friction, includes determining an actual steering load, determining a nominal steering load as a function of vehicle speed, steering angle, and a nominal road friction value, and comparing the actual steering load to the nominal steering load to determine an estimated road friction. In at least some implementations, the nominal steering load is not determined as a function of vehicle yaw, or vehicle lateral acceleration, or vehicle wheel speed compared to vehicle speed, or vehicle tire compliance or road wheel angle.

In at least some implementations, the actual steering load is determined as a function of power provided to or power output from a steering assist motor. In at least some implementations, the actual steering load is determined solely as a function of provided to or power output from a steering assist motor.

In at least some implementations, when the actual steering load is less than the nominal steering load for a given situation it is determined that the estimated road friction is less than the nominal road friction. The method may also include a step of modifying performance of at least one vehicle parameter as a function of the estimated road friction. Modifying performance of at least one vehicle parameter may include changing one or more of the timing, force or rate of actuation one or more of anti-lock brakes, throttle response, brake response, steering assist and vehicle stability control.

In at least some implementations, the nominal road friction value is within a range of 0.8 to 1.0.

In at least some implementations, the method includes empirically determining actual vehicle steering loads for a given vehicle over a range of speeds and steering angles and on a road having the nominal road friction value, and storing the determined actual vehicle steering loads, and wherein the nominal steering load for a particular vehicle speed and a particular steering angle is determined as a function of at least one stored value corresponding to the particular vehicle speed and the particular steering angle.

In at least some implementations, the actual steering load is determined as a function of power to or from a steering assist motor, or from a signal from a steering torque sensor or a signal from a steering rack load sensor.

In at least some implementations, a method of estimating road friction, includes determining a nominal steering load as a function of a nominal surface friction, actual vehicle speed and actual steering angle, and not also as a function of vehicle yaw or vehicle lateral acceleration or vehicle wheel speed compared to vehicle speed or vehicle tire compliance, and comparing the nominal steering load to an actual steering load.

In at least some implementations, the actual steering load is determined as a function of power provided to or power output from a steering assist motor. In at least some implementations, the actual steering load is determined solely as a function of power provided to or power output from a steering assist motor.

In at least some implementations, the method includes estimating road friction as a function of the difference between the nominal steering load and the actual steering load. When the actual steering load is less than the nominal steering load for a given situation it may be determined that the current actual road friction is less than the nominal road friction.

In at least some implementations, the method includes the step of controlling at least one vehicle performance parameter as a function of the current actual road friction. The vehicle performance parameter may include one or more of anti-lock brakes, throttle response, braking force, steering assist and vehicle stability control.

In at least some implementations, the actual steering load is determined as a function of power to or from a steering assist motor, or from a signal from a steering torque sensor or a signal from a steering rack load sensor.

In at least some implementations, the method also includes empirically determining actual vehicle steering loads for a given vehicle over a range of speeds and steering angles and on a road having the nominal road friction value, and storing the determined actual vehicle steering loads, and wherein the nominal steering load for a particular vehicle speed and a particular steering angle is determined as a function of at least one stored values corresponding to the particular vehicle speed and particular steering angle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle showing wheels, part of a steering system and part of a control system;

FIG. 2 is a flowchart of a method for estimating road friction as a function of nominal steering load and actual steering load;

FIG. 3 is a flowchart of a method for estimating road friction and controlling a vehicle system, where nominal steering load is determined as a function of multiple empirically determined steering loads for a given vehicle at various speeds and steering angles on a nominal road;

FIG. 4 is a flowchart of a method for estimating road friction as a function of vehicle speed, steering angle, nominal steering load and actual steering load;

FIG. 5 is a graph of steering assist force as a function of vehicle speed and steering wheel angle;

FIG. 6 is a graph of steering force over time, comparing actual steering force to an estimated steering force on a road having a nominal friction value; and

FIG. 7 is a graph of steering force over time, comparing actual steering force to an estimated steering force on a road having a friction value lower than a nominal value.

### DETAILED DESCRIPTION

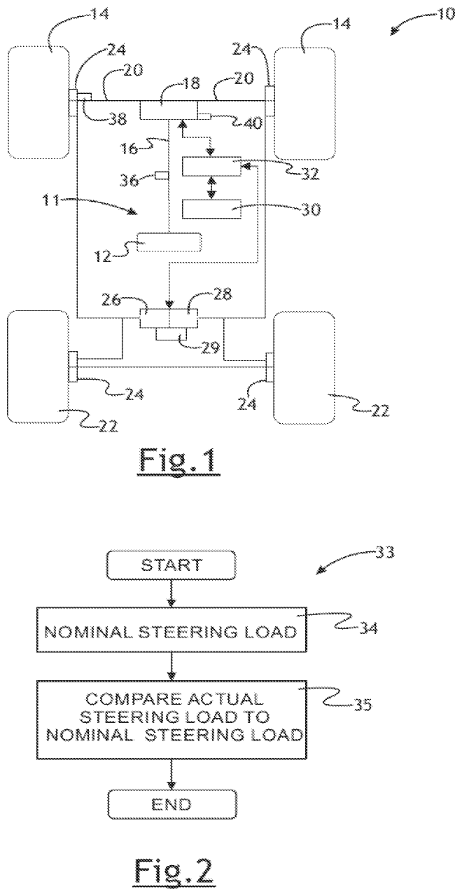

Referring in more detail to the drawings, FIG. 1 illustrates a vehicle 10 having a steering assembly 11 including a steering input 12, which may be a steering wheel, that is coupled to the vehicle front wheels 14 via a known assembly, which may include a steering shaft of column 16, steering rack 18 and associated links/shafts/arms 20 to the front wheels 14. A steer-by-wire system may be used, wherein the steering input 12 is coupled to an actuator which drives the wheels. Rotation of the steering wheel 12 causes rotation of the wheels 14 to steer the vehicle 10. The vehicle 10 may also include two rear wheels 22, and each wheel 14, 22 may include a brake assembly 24. The brake assemblies 24 may be actuated in response to application of a brake pedal by the driver, and/or by an anti-lock brake system 26 or a vehicle stability control 28 system. To propel the vehicle 10, an internal combustion engine and/or one or more electric motors may be provided and is/are coupled to one or more vehicle wheels 14, 22. An electric motor may be associated with one or more of the vehicle wheels 14, 22, an up to each wheel may be driven by a separate electric motor, as desired. The motor or motors may be actuated in response to application of an accelerator pedal by the driver, and/or by the anti-lock brake system 26 or vehicle stability control system 28.

The vehicle 10 as shown includes a steering assist actuator 30, which may be an electrically driven motor that provides an output torque to reduce the steering effort required to steer the vehicle 10, in at least some driving conditions. These systems, as well as the steering assist actuator 30, and various sensors are coupled to or communicated with one or more electronic controllers 32 of the vehicle 10, one of which is shown in FIG. 1.

To estimate the friction of a road on which the vehicle 10 is traveling, as shown in the method 33 illustrated in FIG. 2, a nominal steering load is determined in step 34 and is compared to an actual steering load in step 35. The nominal steering load is determined based upon a steering angle and vehicle speed, and is determined further based upon a nominal road surface have a nominal road friction value. “Nominal” in the context of “nominal road friction value” means a standard or designed for road friction level and not a negligible or very low friction value. In at least some implementations, a relatively high friction value, such as that for a clean, paved road, is selected as the base or designed for or “nominal” road friction value as the implementation described is for a passenger vehicle intended for travel primarily on paved roads. Such a road may have a coefficient of friction value of μ=0.8 to 0.9, which may be the nominal road friction value, in at least some implementations. A typical gravel road may have a coefficient of friction of about μ=0.5, a snowy road about μ=0.2, and an icy road about μ=0.05 to μ=0.1.

Steering angle can be determined by sensing a position of any portion of the steering assembly 11 that changes in a manner that corresponds to intended vehicle direction as indicated by movement of the steering input 12. For example, the steering angle may be determined by sensing or determining the steering input 12 rotary angle or a vehicle wheel angle, or a position of the steering rack or the like. These angles may be measured by one or more sensors 36 (FIG. 1) associated with the steering assembly 11.

The vehicle speed may be determined in any suitable manner including from a signal from a vehicle sensor 38, or data from radar or GPS systems. It is common for vehicles to include a speedometer that displays a vehicle speed, and it is common for other vehicle systems to utilize data relating to vehicle speed, and one or more existing vehicle speed signals or sources may be used, as desired.

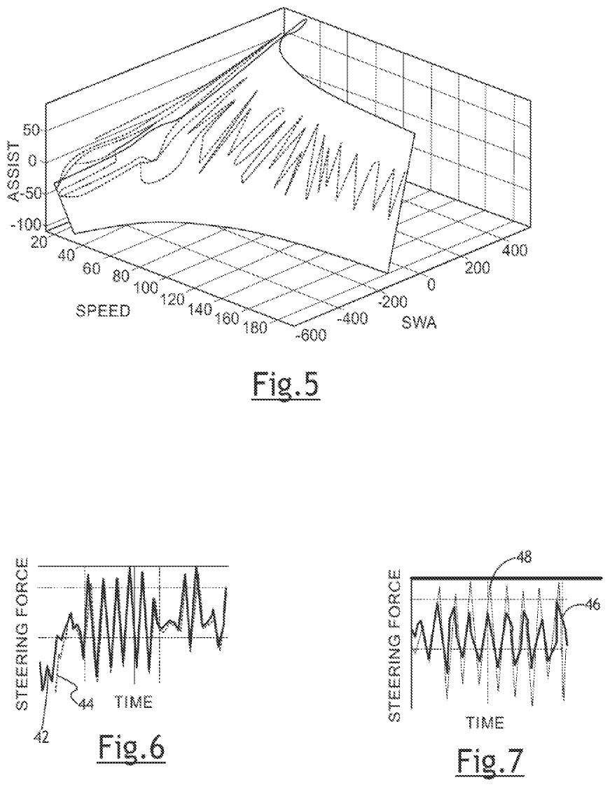

In at least some implementations, the nominal steering load is determined only as a function of the steering angle and vehicle speed with reference to a nominal road friction value. Those inputs are used to determine a nominal steering load which is, or is a function of, the steering load that would be present if the vehicle 10 were on a road having the nominal road friction value. Thus, the nominal steering load is not based upon the actual road friction value or an estimated road friction value, but is determined based upon a nominal road friction value. The nominal steering load may be determined via an algorithm, or look up, via a data source such as a look-up table or map of values, such as is shown in FIG. 5. Such data source may be populated by data acquired empirically, that is, in operation of a vehicle 10 on a suitable road having a desired/nominal road friction value. Thus, for a given vehicle 10, the steering load on a nominal road surface can be empirically determined and stored/recorded at multiple vehicle speeds and steering angles, and such data can then be used to perform calculation of the nominal steering load across a wide range of vehicle operating conditions. Thus, in at least some implementations, the nominal steering load for a particular vehicle speed and a particular steering angle may be determined as a function of at least one stored value corresponding to the particular vehicle speed and the particular steering angle.

The actual steering load may be determined in different ways, such as by one or more sensors 40 that detect or indicate a load on the steering rack 18 or other portion of the steering assembly 11, or a power supplied to or output from the steering assist actuator 30. The actual steering load is indicative of the current, actual steering effort in the steering assembly 11 of the moving vehicle 10.

Differences in actual steering load at various steering angles and vehicle speeds occur when the vehicle 10 is on a road having an actual road friction value that is different than the nominal road friction value (or perhaps changes in tire grip which may have the same or a similar effect). The difference between the actual steering load and the nominal steering load can be used to estimate the actual road friction value. For example, if the actual steering load is less than the nominal steering load it can be determined that the actual road friction value is less than the nominal road friction value, as less road friction permits less steering effort/load to turn the vehicle wheels. If the actual steering load is greater than the nominal steering load it can be determined that the actual road friction value is greater than the nominal road friction value as greater road friction requires greater steering effort/load to turn the vehicle wheels. Further, the magnitude of the difference between actual steering load and nominal steering load can be used to estimate the actual road friction, where a greater difference means the actual road friction value differs more greatly from the nominal road friction value than does a lesser difference.

FIG. 6 illustrates a plot of actual steering force, shown by line 42, and nominal steering load, shown by line 44. There is very little difference in these plots which indicates that the vehicle 10 was traveling on a road having a friction value equal or very nearly equal to the nominal road friction value. FIG. 7 illustrates a plot of actual steering force, shown by line 46, and nominal steering load, shown by line 48. There is a significant difference in these plots (e.g. a difference in the magnitude of steering force) which indicates that the vehicle 10 was traveling on a road having a friction value different than the nominal road friction value. Because the actual steering load in FIG. 7 is less than the nominal steering load, it can be determined that vehicle 10 was traveling on a road having a lower coefficient of friction than the nominal road friction value. Further, while the magnitude of steering force varies as a function of surface friction, the simple, fast and low noise information used to estimate road friction enables the estimated and actual forces to be in-phase, as is shown in both FIGS. 6 and 7. Systems that require lateral acceleration and/or yaw data are delayed, and hence out of phase, and such delays must be accounted for and compensated for in the road friction estimation process which further complicates those systems.

Thus, as shown in FIG. 3, a method 49 of estimating road friction may be accomplished by, in step 50, empirically determining multiple steering loads at different vehicle speeds and/or steering angles. Then, in step 52, an actual steering load can be determined while the vehicle is moving, and the actual steering load is compared to a nominal steering load in step 54. The nominal steering load is determined as a function of the empirical data acquired in step 50. Then, based on a comparison of the actual steering load to the nominal steering load, in step 56 control of one or more vehicle systems may be altered at least when a large enough difference is present between the actual steering load and the nominal steering load.

The actual road friction can be used to modify control of one or more vehicle systems or parameters. For example, one or more of 1) the force provided from the steering assist actuator 30 may be adjusted to account for the difference in steering effort required for the different road friction value; 2) the accelerator response may be adjusted (e.g. to reduce acceleration rate when the estimated road friction value is less than the nominal road friction value or to permit increased acceleration rate when the estimated road friction value is greater than the nominal road friction value); 3) the brake response may be adjusted (e.g. to reduce deceleration rate when the estimated road friction value is less than the nominal road friction value or to permit increased deceleration rate when the estimated road friction value is greater than the nominal road friction value); 4) the performance of the anti-lock brake system 26 may be adjusted (e.g. actuation timing and/or force and or rate); 5) the performance of the vehicle stability control system 28 may be adjusted (e.g. actuation timing and/or force and or rate); 6) the performance of a traction control system 29; 7) the performance of a selectable two-wheel or all-wheel drive system; or 8) the performance of a rear wheel steering system.

In at least some implementations, the estimated road friction is determined without regard to and not as a function of vehicle yaw, or vehicle lateral acceleration, or vehicle wheel speed compared to vehicle speed, or vehicle tire compliance. Using vehicle yaw or vehicle lateral acceleration or vehicle wheel speed compared to vehicle speed requires some slipping or sliding of the vehicle tires relative to the road. Thereafter, the control system can react and actuate the ABS 26 or stability control system 28 or traction control system 29 to terminate the slipping or sliding event. Thus, the vehicle is controlled reactively, after some slipping or sliding event, and the magnitude of the system intervention may be done as a function of the rate/magnitude of the slipping or sliding event.

When the friction limit is exceeded by a greater magnitude, a greater slipping or sliding occurs before the control system reacts and the slipping or sliding event can be terminated, and the magnitude and duration of the system intervention (e.g. braking/throttle reduction, etc) is longer which is more noticeable to an occupant of the vehicle and more disruptive to the driving experience. Such reactive systems often must overshoot the control, that is, provide a greater amount (e.g. magnitude or rate or duration) of intervention control to bring the already sliding or slipping vehicle under control.

Further, in addition to being delayed, yaw rate and lateral acceleration signals are noisy and must be significantly filtered which further limits the ability to achieve finer system control with these signals. For example, a bumpy road can cause accelerations that result in data from a gyroscopic sensor that must be filtered out. Further, systems that utilize complex methods to determine inputs like tire compliance and/or road wheel angle are complicated and require allowing for kinematics and compliance of all joints/connections and parts between the steering input 12 and the road (bushings may compress or stretch, there is clearance between connected parts, tires flex on the road, etc), and such kinematics and compliance are different at different vehicle speeds. These systems are slower to react due at least in part to the increased information needed to make a determination and due to the filtering required.

Vehicle speed and steering angle are readily available signals with high signal to noise ratios that do not require extensive filtering. Steering angle is not dependent upon all of the kinematic and compliance issues that road wheel angle is, so steering angle is easier to determine, can be determined quickly and reliably. Further, the steering angle changes before the road wheel angle changes and thus, use of steering angle enables quicker estimation of road friction than if road wheel angle were used. Yaw and lateral acceleration signals require full vehicle movement whereas the steering is done at the front of the vehicle 10, via the front wheels 14 (in this example), and so steering angle and even steering rack load changes before road wheel angle and before yaw or lateral acceleration data is available.

Next, the steering assist actuator 30 force is a function of or proportional to steering rack load or steering column torque. The steering assist actuator 30 signal is easy to obtain with high resolution, and is fast/responsive in that a signal to the steering assist actuator 30 is provided before road wheel angle actually changes and before a change in load on the steering shaft 16 or steering rack 18 which occurs as the actuator 30 applies a force on the steering assembly 11 in response to the signal provided to the actuator. Thus, this further improves response time compared to systems that utilize road wheel angle or steering torque (e.g. steering column torque) or steering rack load.

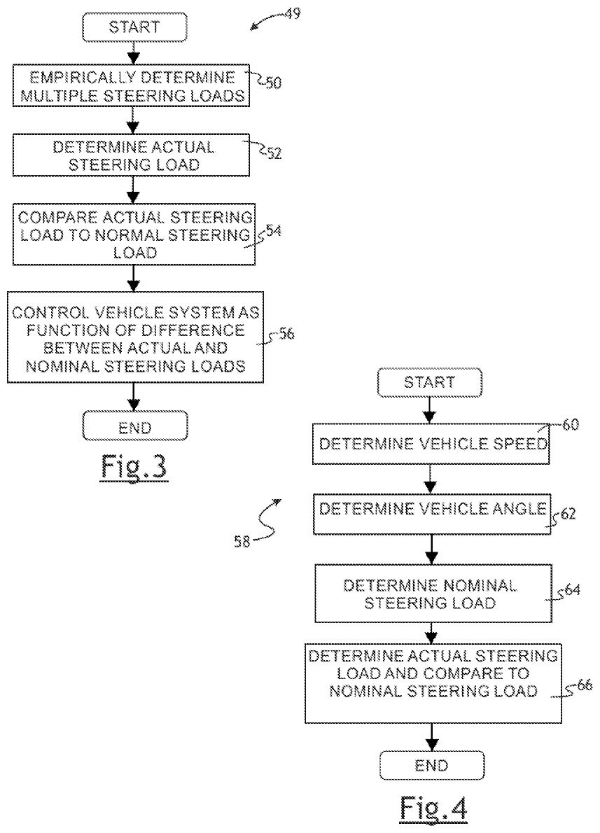

A method 58 for estimating road friction, as shown in FIG. 4, may include determining vehicle speed and steering angle (steps 60, 62) and from those variables determining a nominal steering load (step 64). The nominal steering load may then be compared to an actual steering load in step 66, where the actual steering load may be based upon a signal from the power steering assist actuator 30. All signals/data used in the determinations and comparison are readily available and of high quality which facilitates the determinations and improves the responsiveness of the system.

In addition to or instead of the signal to the steering assist actuator 30, the system may use steering torque, steering rack load to determine actual steering load, if desired, although such signals may require more filtering than the steering assist actuator 30 signal. Steering torque and steering rack load are sometimes used in other vehicle systems, and thus, may be readily available, if their use is desired as the primary input 12 of steering load or as a backup or complementary signal of steering load.

Using the easy, low noise/accurate and fast to obtain steering angle and steering assist actuator 30 signals enables rapid determination of an estimated road friction as a simple comparison between actual steering load and an estimated steering load for the actual vehicle speed and steering angle. The road friction value can be estimated without requiring vehicle yaw or lateral accelerations or tire slippage on the road, or calculations of tire compliance and other complex kinematic and compliance variables. Therefore, the vehicle 10 may be controlled more proactively than the more complex and slower systems. Vehicle operational parameters may be controlled before tire slippage or sliding occurs and thus, controls may be implemented at a slower rate and/or at lower magnitude to control the vehicle 10 in a manner less noticeable to vehicle occupants and less disruptive to the driving experience.

In at least some implementations, the steering assist actuator 30 signal is used to empirically determine steering load at various speeds and steering angles. In one example, data for a test or representative vehicle was collected as a vehicle speed was increased while steering angle was slowly increased. The data was then used to create a multi-variate regression equation and a 3D model was plotted, as shown in FIG. 5 in which a steering assist force is plotted on the y-axis, vehicle speed is plotted on the x-axis and steering wheel 12 angle is plotted on the z-axis. An example of one type of equation that can be made with this method is:

f(x=speed,y=steering angle)=p00+p10*x+p01*y+p20*x\hat{ }2+p11*x*y+p02*y\hat{ }2+p21*x\hat{ }2*y+p12*x*y\hat{ }2+p03*y\hat{ }3

Coefficients (with 95% confidence bounds):

p00 = −0.04958 (−0.05138, −0.04778)
p10 = 0.005224 (0.005186, 0.005262)
p01 = −0.002751 (−0.002769, −0.002734)
p20 = −5.477e−05 (−5.496e−05, −5.459e−05)
p11 = 0.006993 (0.006993, 0.006994)
p02 = 1.132e−05 (1.13e−05, 1.135e−05)
p21 = 7.026e−06 (7.021e−06, 7.031e−06)
p12 = −1.832e−06 (−1.834e−06, −1.831e−06)
p03 = −1.057e−07 (−1.057e−07, −1.057e−07).

The above data was obtained without compensation for hysteresis in steering angle, and accuracy can be further improved by accounting for such hysteresis, if desired.

Some vehicles have multiple steering modes that provide different assist levels, like normal or touring, sport and track modes. The estimated steering load data can be generated or collected in each mode and the steering assist level used to determine actual steering load can be adjusted according to the mode in which the vehicle 10 is being operated.

What is claimed is:

1. A method of estimating road friction, comprising:
determining an actual steering load;
determining a nominal steering load as a function of vehicle speed, steering angle, and a nominal road friction value; and
comparing the actual steering load to the nominal steering load to determine an estimated road friction.

2. The method of claim 1 wherein the nominal steering load is not determined as a function of vehicle yaw, or vehicle lateral acceleration, or vehicle wheel speed compared to vehicle speed, or vehicle tire compliance or road wheel angle.

3. The method of claim 1 wherein the actual steering load is determined as a function of power provided to or power output from a steering assist actuator.

4. The method of claim 1 wherein the actual steering load is determined solely as a function of provided to or power output from a steering assist actuator.

5. The method of claim 1 wherein when the actual steering load is less than the nominal steering load for a given situation it is determined that the estimated road friction is less than the nominal road friction.

6. The method of claim 5 which also comprises the step of modifying performance of at least one vehicle parameter as a function of the estimated road friction.

7. The method of claim 6 wherein modifying performance of at least one vehicle parameter includes changing one or more of the timing, force or rate of actuation one or more of anti-lock brakes, throttle response, brake response, steering assist and vehicle stability control.

8. The method of claim 1 wherein the nominal road friction value is within a range of 0.8 to 0.9.

9. The method of claim 1 which also includes empirically determining actual vehicle steering loads for a given vehicle over a range of speeds and steering angles and on a road having the nominal road friction value, and storing the determined actual vehicle steering loads, and wherein the nominal steering load for a particular vehicle speed and a particular steering angle is determined as a function of at least one stored values corresponding to the particular vehicle speed and the particular steering angle.

10. The method of claim 1 wherein the actual steering load is determined as a function of power to or from a steering assist actuator, or from a signal from a steering torque sensor or a signal from a steering rack load sensor.

11. A method of estimating road friction, comprising:
determining a nominal steering load as a function of a nominal surface friction, actual vehicle speed and actual steering angle, and not also as a function of vehicle yaw or vehicle lateral acceleration or vehicle wheel speed compared to vehicle speed or vehicle tire compliance; and
comparing the nominal steering load to an actual steering load.

12. The method of claim 11 wherein the actual steering load is determined as a function of power provided to or power output from a steering assist motor.

13. The method of claim 11 wherein the actual steering load is determined solely as a function of power provided to or power output from a steering assist motor.

14. The method of claim 11 which also comprises estimating road friction as a function of the difference between the nominal steering load and the actual steering load.

15. The method of claim 14 wherein when the actual steering load is less than the nominal steering load for a given situation it is determined that the estimated road friction is less than the nominal road friction.

16. The method of claim 15 which also comprises the step of controlling at least one vehicle performance parameter as a function of the estimated road friction.

17. The method of claim 16 wherein said at least one vehicle performance parameter includes one or more of anti-lock brakes, throttle response, braking force, steering assist and vehicle stability control.

18. The method of claim 11 wherein the actual steering load is determined as a function of power to or from a steering assist motor, or from a signal from a steering torque sensor or a signal from a steering rack load sensor.

19. The method of claim 11 which also includes empirically determining actual vehicle steering loads for a given vehicle over a range of speeds and steering angles and on a road having the nominal road friction value, and storing the determined actual vehicle steering loads, and wherein the nominal steering load for a particular vehicle speed and a particular steering angle is determined as a function of at least one stored values corresponding to the particular vehicle speed and particular steering angle.
